(19) United States
(12) Patent Application Publication
(10) Pub. No.: US 2022/0278881 A1
(43) Pub. Date: Sep. 1, 2022

(54) SOUNDING REFERENCE SIGNAL CONFIGURATION FOR FULL BANDWIDTH TRANSMISSION

(71) Applicant: Telefonaktiebolaget LM Ericsson (publ), Stockholm (SE)

(72) Inventors: Florent MUNIER, Västra Frölunda (SE); Per ERNSTRÖM, Stockholm (SE); Erik STARE, Sollentuna (SE)

(21) Appl. No.: 17/634,750

(22) PCT Filed: Aug. 13, 2020
(86) PCT No.: PCT/SE2020/050782

§ 371 Date: Feb. 11, 2022

Related U.S. Application Data
(60) Provisional application No. 62/888,252, filed on Aug. 16, 2019.

(51) Int. Cl. H04L 27/26; H04L 5/00; H04W 16/28

(52) U.S. Cl. CPC H04L 27/2613; H04L 27/2607; H04L 5/0051; H04W 16/28

(57) ABSTRACT

A method, wireless device and network node for sounding reference signal (SRS) configuration for full bandwidth transmission are disclosed. According to one aspect, a method includes determining a sounding reference signal, SRS, pattern within a resource, the SRS pattern being based at least in part on at least one of a comb size, at least one comb offset, at least one cyclic shift and a number of orthogonal frequency division multiplexing, OFDM, symbols within the resource; and optionally, sending a configuration specifying the SRS pattern.

### TECHNICAL FIELD

The present disclosure relates to wireless communication and in particular, to sounding reference signal (SRS) configuration for full bandwidth transmission.

### BACKGROUND

New Radio (NR) Positioning

Positioning has been a topic in Long Term Evolution (LTE) standardization since Release 9 (Rel-9) of the 3^{rd} Generation Partnership Project (3GPP) standard. An objective is to fulfill regulatory requirements for emergency call positioning. Positioning in New Radio (NR), also referred to as 5^{th} Generation (5G), is proposed to be supported by the architecture shown in FIG. 1, which is a schematic diagram including a user equipment 2 (UE), a Next Generation Radio Access Network (NG-RAN) 4, an Access and Mobility Management Function 6 (AMF), a Location Management Function (LMF) 8 and an evolved Serving Mobile Location Center 9 (E-SMLC). The LMF 8 is the location node in NR. There are also interactions between the location node and the base station (gNodeB) via the NR Positioning Protocol A (NRPPa). The interactions between the gNodeB and the device (e.g., UE 2) is supported via the Radio Resource Control (RRC) protocol. As to FIG. 1, note that a gNB and ng-eNB may not always both be present in the NG-RAN 4. Further, when both the gNB and ng-eNB are present, the NG-C interface is only present for one of them.

In legacy LTE standards, the following techniques are supported:
(1) Enhanced Cell ID. Essentially, cell identifier (ID) information to associate the device (e.g., UE 2) to the serving area of a serving cell, and then additional information to determine a finer granularity position;
(2) Assisted Global Navigation Satellite System (GNSS). GNSS information retrieved by the device (e.g., UE 2), supported by assistance information provided to the device (e.g., UE 2) from E-SMLC 9; and
(3) OTDOA (Observed Time Difference of Arrival). The UE 2 estimates the time difference of reference signals from different base stations and sends to the evolved Serving Mobile Location Center 9 (E-SMLC) for multi-lateration.
(4) UTDOA (Uplink TDOA). The UE 2 is requested to transmit a specific waveform that is detected by multiple location measurement units (e.g., an eNB) at known positions. These measurements are forwarded to E-SMLC 9 for multilateration

The NR positioning for 3GPP Release 16 (Rel. 16), based on the 3GPP NR radio technology, can add value in terms of enhanced location capabilities. The operation in low and high frequency bands (i.e., below and above 6 GHz) and utilization of massive antenna arrays provide additional degrees of freedom to substantially improve the positioning accuracy. The possibility of using wide signal bandwidth in low and especially in high bands brings new performance bounds for user location for well-known positioning techniques based OTDOA and UTDOA, Cell-ID or E-Cell-ID, etc., utilizing timing measurements to locate a device, such as UE 2, which may interchangeably be referred to as a wireless device (WD). The recent advances in massive antenna systems (massive multiple-input multiple-out or MIMO) can provide additional degrees of freedom to enable a more accurate user location estimation by exploiting spatial and angular domains of the propagation channel in combination with time measurements.

With 3GPP Rel-9, Positioning Reference Signals (PRS) have been introduced for antenna port 6 as the Rel-8 cell-specific reference signals generally are not sufficient for positioning. A reason is that the required high probability of detection could not be guaranteed. A neighbor cell with its synchronization signals (Primary/Secondary Synchronization Signals, PSS/SSS) and reference signals is seen as detectable, when the Signal-to-Interference-and-Noise Ratio (SINR) is at least −6 dB. Simulations during standardization have shown, however, that this can be only guaranteed for 70% of all cases for the 3rd best-detected cell, which means 2nd best neighboring cell. This is not enough, and it has been assumed an interference-free environment, which cannot be ensured in a real-world scenario. However, PRS still have some similarities with cell-specific reference signals (CRS) as defined in 3GPP Rel-8. It is a pseudo-random quadrature phase shift keyed (QPSK) sequence that is being mapped in diagonal patterns with shifts in frequency and time to avoid collision with cell-specific reference signals and an overlap with the physical downlink control channels (PDCCH).

In NR, the PRS is yet to be finalized. Candidates for the PRS may include transmit reference signal (TRS), Extended-TRS and LTE-like PRS, etc. In this disclosure, the term Positioning Reference Signal (PRS) is used where a PRS can be any of the NR reference signals or a new reference signal.

The sounding reference signal (SRS) is transmitted in the UL to allow CSI measurements to be performed, mainly for scheduling and link adaptation. For NR, the SRS may also be utilized for reciprocity-based precoder design for massive multiple input multiple output (MIMO) and uplink (UL) beam management. The SRS may have a modular and flexible design to support different procedures and wireless device (WD) capabilities. SRS has been selected in 3GPP for the UL UTDOA positioning method in NR.

Sounding Reference Signal (SRS)

In LTE and NR, the SRS is configured via radio resource control (RRC) signaling. The configuration includes the SRS resource allocation as well as the aperiodic or periodic or semi-persistent behavior. For aperiodic transmission, a dynamic trigger is transmitted via the physical downlink control channel (PDCCH) downlink control information (DCI) in the downlink from the base station to instruct the WD to transmit the SRS at a predetermined time.

SRS Resource Configuration

The SRS configuration enables generation of a transmission pattern based on resource configuration grouped in resource sets. Each resource is configured with the following abstract syntax notation (ASN) code via RRC:

| | |
|---|---|
| SRS-Resource ::= | SEQUENCE { |
| srs-ResourceId | SRS-ResourceId, |
| nrofSRS-Ports | ENUMERATED {port1, ports2, ports4}, |
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
      }
    },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, |

groupHopping, sequenceHopping },

| | |
|---|---|
| resourceType | CHOICE { |
| aperiodic | SEQUENCE { |

```
        ...
      },
```

| | |
|---|---|
| semi-persistent | SEQUENCE { |
| periodicityAndOffset-sp | SRS-PeriodicityAndOffset, |

```
        ...
      },
```

| | |
|---|---|
| periodic | SEQUENCE { |
| periodicityAndOffset-p | SRS-PeriodicityAndOffset, |

```
        ...
      }
    },
```

| | |
|---|---|
| sequenceId | INTEGER (0..1023), |
| spatialRelationInfo | SRS-SpatialRelationInfo |

OPTIONAL, -- Need R
...}

To create the SRS on the time frequency grid with the current radio resource control (RRC) configuration, each SRS resource is thus configurable with respect to:

the transmission comb, possibly of size 2 and 4;

with each resource a comb offset is specified, as well as a cyclic shift;

a starting position in time, which is limited to the last 6 symbols in a slot;

a number of symbols, up to 4; and/or

a repetition factor, up to 4×.

Additionally, the frequency domain position (i.e., which part of the system bandwidth is occupied) is configured with the RRC parameters freqDomainPosition, freqDomainShift, freqHopping. The resourceType parameter configures whether the resource is periodic, aperiodic, or semi persistent. The sequenceId parameters specify how the SRS sequence is initialized and spatialRelationInfo configures the spatial relation for the SRS beam with another reference signal (RS) which can be either another SRS, SSB or CSI-RS.

Resource Set Configuration

The SRS resource is configured as part of a resource set. Within a resource set, the following parameters (common to all resources in the set) may be configured in RRC:

the associated downlink reference signal, channel state information reference signal (CSI-RS) resource for each of the possible resource e types (aperiodic, periodic, semi persistent). Note that all resources in a resource set must share the same resource type;

for the aperiodic resources the slot offset which sets the delay from the trigger reception to transmission of the SRS in slots and resource triggers which are DCI codepoint signaling to transmit that resource;

the resource usage, which sets constraints and assumption on the resource properties (see 3GPP Technical Standard (TS) 38.214); and

the power control parameter alpha, p0, pathlossreferenceRS (signaling the downlink RS that can be used for path loss estimation) and srs-PowerControlAdjustmentStates.

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS- |
| ResourcesPerSet)) OF SRS-ResourceId | OPTIONAL, -- Cond Setup |
| resourceType | CHOICE { |
| aperiodic | SEQUENCE{ |
| aperiodicSRS-ResourceTrigger | INTEGER (1..maxNrofSRS- |

TriggerStates-1),

| | |
|---|---|
| csi-RS | NZP-CSI-RS-ResourceId |

OPTIONAL, -- Cond NonCodebook

| | |
|---|---|
| slotOffset | INTEGER (1..32) |

```
OPTIONAL, -- Need S
        ...,
        [[
```

| | |
|---|---|
| aperiodicSRS-ResourceTriggerList-v1530 | SEQUENCE |

(SIZE(1..maxNrofSRS-TriggerStates-2))

OF INTEGER (1..maxNrofSRS-

```
TriggerStates-1) OPTIONAL -- Need M
        ]]
      },
```

| | |
|---|---|
| semi-persistent | SEQUENCE { |
| associatedCSI-RS | NZP-CSI-RS-ResourceId |

```
OPTIONAL, -- Cond NonCodebook
        ...
      },
```

| | |
|---|---|
| periodic | SEQUENCE { |
| associatedCSI-RS | NZP-CSI-RS-ResourceId |

```
OPTIONAL, -- Cond NonCodebook
        ...
      }
    },
```

| | |
|---|---|
| usage | ENUMERATED {beamManagement, |

codebook, nonCodebook, antennaSwitching},

| | |
|---|---|
| alpha | Alpha |

OPTIONAL, -- Need S

| | |
|---|---|
| p0 | INTEGER (−202..24) |

OPTIONAL, -- Cond Setup

| | |
|---|---|
| pathlossReferenceRS | CHOICE { |
| ssb-Index | SSB-Index, |
| csi-RS-Index | NZP-CSI-RS-ResourceId |
| } | OPTIONAL, |

-- Need M

| | |
|---|---|
| srs-PowerControlAdjustmentStates | ENUMERATED { sameAsFci2, |
| separateClosedLoop} | OPTTONAL, -- Need S |

...}

Hence it can be seen that in terms of resource allocation, the resource set configuration configures resource usage, power control, aperiodic transmission timing, and downlink (DL) resource association for e.g., all resources in the set; while the resource configuration controls the time and frequency allocation, the periodicity and offset of each resource, the sequence ID for each resource and the spatial relation information.

SRS Resource Configuration in Release 16

During Rel-16, a new use for SRS, ‘positioning’ was considered for handling the case of SRS used for the sake of positioning. Within this use, an SRS resource may be configured with a comb-based pattern that is more flexible than the one available in Rel-15 and for other usage. How to realize the pattern has not been discussed yet and is subject to further agreements. The pattern can be configured to have a staggered frequency shift over the symbols present in the resource, something not allowed in earlier releases of NR. The comb size, number of symbols, and exact details on the staggered pattern are still under discussion. Resources in a resource set with usage “positioning” are expected to be beams that are pointed at one or more base stations (gNbs).

The current 3GPP specification does not have configurations to realize the full bandwidth SRS within one resource. The following have been considered recently in 3GPP:

Considerations:

SRS transmissions for positioning are realized with staggered patterns (a collection of SRS symbols from the same antenna port with different offsets for at least some symbols) in a single SRS resource:
FFS: construction of the pattern inside the SRS resource structure.
Considerations:
For positioning, the number of consecutive orthogonal frequency division multiplexing (OFDM) symbols in an SRS resource is configurable with one of the values in the set {1, 2, 4, 8, 12}:
FFS: Other values including 3, 6, 14;
Note: Values of 1, 2 and 4 within an SRS resource can already be configured in Rel-15.
Considerations:
For positioning, the SRS comb size set is extended from {2,4} to {2,4,8}:
FFS: Additional comb sizes: 1, 6, 12;
   Note: For the comb sizes of 6 and 12, the number of physical resource blocks (PRBs) may be restricted if currently defined sequences are to be used;
FFS: Maximum number of cyclic shifts for the different comb sizes (cyclic shifts for comb sizes of 2 and 4 already exist in Rel-15).

### SUMMARY

Some embodiments advantageously provide methods and network nodes for sounding reference signal (SRS) configuration for full bandwidth transmission.

Some embodiments configure the SRS resource with a pattern controlled by the comb offset, comb size and number of symbols to realize a full bandwidth SRS within a single resource. Additionally, extension to include more than the currently standardize cyclic shifts are described.

According to one aspect of the present disclosure, a method implemented in a network node is provided. The method includes determining a sounding reference signal, SRS, pattern within a resource, the SRS pattern being based at least in part on at least one of a comb size, at least one comb offset, at least one cyclic shift and a number of orthogonal frequency division multiplexing, OFDM, symbols within the resource. The method includes optionally, sending a configuration specifying the SRS pattern.

In some embodiments of this aspect, each symbol of the SRS pattern is configured to have a specific comb offset. In some embodiments of this aspect, the configuration specifying the SRS pattern is a radio resource control, RRC, configuration and at least one symbol of the SRS pattern is configured independently in the RRC configuration. In some embodiments of this aspect, the configuration specifying the SRS pattern includes a vector, at least one vector element in the vector specifying a comb offset for a corresponding OFDM symbol within the resource. In some embodiments of this aspect, the SRS pattern is a fixed pattern. In some embodiments of this aspect, the fixed pattern is dependent on the comb size. In some embodiments of this aspect, the SRS pattern is one of repeated and truncated based on the number of OFDM symbols that are configured within the resource.

In some embodiments of this aspect, the configuration specifying the SRS pattern is a radio resource control, RRC, configuration and the SRS pattern is shifted in frequency according to a comb offset parameter in the RRC configuration. In some embodiments of this aspect, when the comb size is 6, a minimum SRS bandwidth is a multiple of 12 physical resource blocks, PRBs, up to 20 PRBs. In some embodiments of this aspect, when the comb size is 12, a minimum SRS bandwidth is a multiple of 12 physical resource blocks, PRBs, up to 24 PRBs. In some embodiments of this aspect, when the comb size is 2, the at least one cyclic shift includes up to 8 cyclic shifts.

In some embodiments of this aspect, when the comb size is 4, the at least one cyclic shift includes up to 12 cyclic shifts. In some embodiments of this aspect, the method includes determining a number of orthogonal cyclic shift signals, the number of orthogonal cyclic shift signals being based at least in part on a maximum tolerated delay. In some embodiments of this aspect, a maximum number of cyclic shifts is a multiple of a number of cyclic shifts in a legacy radio access technology. In some embodiments of this aspect, a maximum number of cyclic shifts is configured at least one of: as part of a resource configuration of the resource; per resource; and independently of the comb size. In some embodiments of this aspect, the resource is a single SRS resource configured to have the determined SRS pattern. In some embodiments of this aspect, the method further includes receiving an SRS beam on the resource according to the configuration specifying the SRS pattern; and using the received SRS beam for a positioning purpose.

According to an aspect of the present disclosure, a network node configured to communicate with a wireless device, WD, is provided. The network node includes processing circuitry. The processing circuitry is configured to cause the network node to determine a sounding reference signal, SRS, pattern within a resource, the SRS pattern being based at least in part on at least one of a comb size, at least one comb offset, at least one cyclic shift and a number of orthogonal frequency division multiplexing, OFDM, symbols within the resource; and optionally, send a configuration specifying the SRS pattern.

In some embodiments of this aspect, each symbol of the SRS pattern is configured to have a specific comb offset. In some embodiments of this aspect, the configuration specifying the SRS pattern is a radio resource control, RRC, configuration and at least one symbol of the SRS pattern is configured independently in the RRC configuration. In some embodiments of this aspect, the configuration specifying the SRS pattern includes a vector, at least one vector element in the vector specifying a comb offset for a corresponding OFDM symbol within the resource. In some embodiments of this aspect, the SRS pattern is a fixed pattern. In some embodiments of this aspect, the fixed pattern is dependent on the comb size.

In some embodiments of this aspect, the SRS pattern is one of repeated and truncated based on the number of OFDM symbols that are configured within the resource. In some embodiments of this aspect, the configuration specifying the SRS pattern is a radio resource control, RRC, configuration and the SRS pattern is shifted in frequency according to a comb offset parameter in the RRC configuration. In some embodiments of this aspect, when the comb size is 6, a minimum SRS bandwidth is a multiple of 12 physical resource blocks, PRBs, up to 20 PRBs. In some embodiments of this aspect, when the comb size is 12, a minimum SRS bandwidth is a multiple of 12 physical resource blocks, PRBs, up to 24 PRBs.

In some embodiments of this aspect, when the comb size is 2, the at least one cyclic shift includes up to 8 cyclic shifts. In some embodiments of this aspect, when the comb size is 4, the at least one cyclic shift includes up to 12 cyclic shifts. In some embodiments of this aspect, the processing circuitry is further configured to cause the network node to determine a number of orthogonal cyclic shift signals, the number of orthogonal cyclic shift signals being based at least in part on a maximum tolerated delay. In some embodiments of this aspect, a maximum number of cyclic shifts is a multiple of a number of cyclic shifts in a legacy radio access technology.

In some embodiments of this aspect, a maximum number of cyclic shifts is configured at least one of: as part of a resource configuration of the resource; per resource; and independently of the comb size. In some embodiments of this aspect, the resource is a single SRS resource configured to have the determined SRS pattern. In some embodiments of this aspect, the processing circuitry is configured to cause the network node to receive an SRS beam on the resource according to the configuration specifying the SRS pattern; and use the received SRS beam for a positioning purpose.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example of a 3GPP 5G architecture;

FIG. 2 is a schematic diagram of an exemplary network architecture illustrating a communication system connected via an intermediate network to a host computer according to the principles in the present disclosure;

FIG. 3 is a block diagram of a host computer communicating via a network node with a wireless device over an at least partially wireless connection according to some embodiments of the present disclosure;

FIG. 4 is a flowchart illustrating exemplary methods implemented in a communication system including a host computer, a network node and a wireless device for executing a client application at a wireless device according to some embodiments of the present disclosure;

FIG. 5 is a flowchart illustrating exemplary methods implemented in a communication system including a host computer, a network node and a wireless device for receiving user data at a wireless device according to some embodiments of the present disclosure;

FIG. 6 is a flowchart illustrating exemplary methods implemented in a communication system including a host computer, a network node and a wireless device for receiving user data from the wireless device at a host computer according to some embodiments of the present disclosure;

FIG. 7 is a flowchart illustrating exemplary methods implemented in a communication system including a host computer, a network node and a wireless device for receiving user data at a host computer according to some embodiments of the present disclosure;

FIG. 8 is a flowchart of an exemplary process in a network node according to some embodiments of the present disclosure;

FIG. 9 illustrates a pattern of resources according to some embodiments of the present disclosure; and

FIG. 10 illustrates another pattern of resources according to some embodiments of the present disclosure.

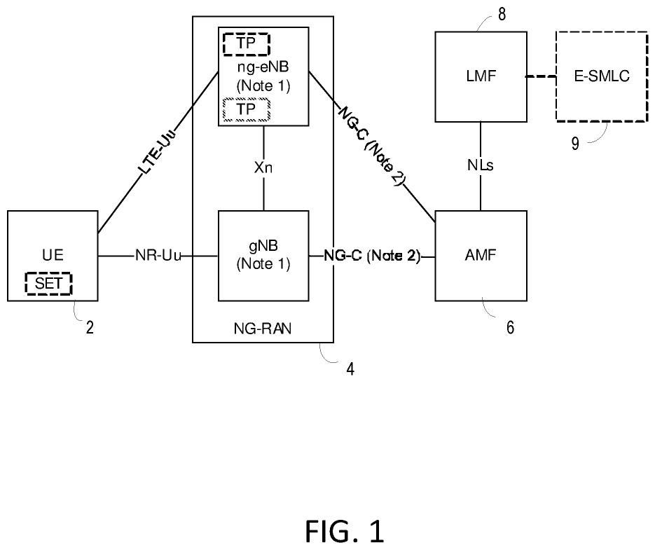

### DETAILED DESCRIPTION

Before describing in detail exemplary embodiments, it is noted that the embodiments reside primarily in combinations of apparatus components and processing steps related to sounding reference signal (SRS) configuration for full bandwidth transmission. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate, and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, integrated access and backhaul (IAB) node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

In some embodiments, the “full bandwidth” may mean the full SRS bandwidth. In some embodiments, the “full bandwidth” may mean full system bandwidth. In some embodiments, the shortened term “resource” may be used interchangeably with “SRS resource.”

Although the description herein may be explained in the context of sounding reference signal (SRS), it should be understood that the principles may also be applicable to other types of reference signals.

Configuring a Radio Node

Configuring a radio node, in particular a terminal or user equipment or the WD, may refer to the radio node being adapted or caused or set and/or instructed to operate according to the configuration. Configuring may be done by another device, e.g., a network node (for example, a radio node of the network like a base station or eNodeB or gNB) or network, in which case it may comprise transmitting configuration data to the radio node to be configured. Such configuration data may represent the configuration to be configured and/or comprise one or more instruction pertaining to a configuration, e.g. a configuration for transmitting and/or receiving on allocated resources, in particular frequency resources, or e.g., configuration for performing certain measurements on certain subframes or radio resources. A radio node may configure itself, e.g., based on configuration data received from a network or network node. A network node may use, and/or be adapted to use, its circuitry/ies for configuring. Allocation information may be considered a form of configuration data. Configuration data may comprise and/or be represented by configuration information, and/or one or more corresponding indications and/or message/s.

Configuring in General

Generally, configuring may include determining configuration data representing the configuration and providing, e.g. transmitting, it to one or more other nodes, such as (parallel and/or sequentially), which may transmit it further to the radio node, e.g., WD (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g. WD) may comprise configuring the WD with an SRS resource and/or SRS pattern according to embodiments of the present disclosure.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

A method and network node for sounding reference signal (SRS) configuration for full bandwidth transmission are disclosed. According to one aspect, a method includes determining a sounding reference signal (SRS) pattern within a resource, each symbol of the SRS pattern being configured to have specific comb offset or cyclic shift.

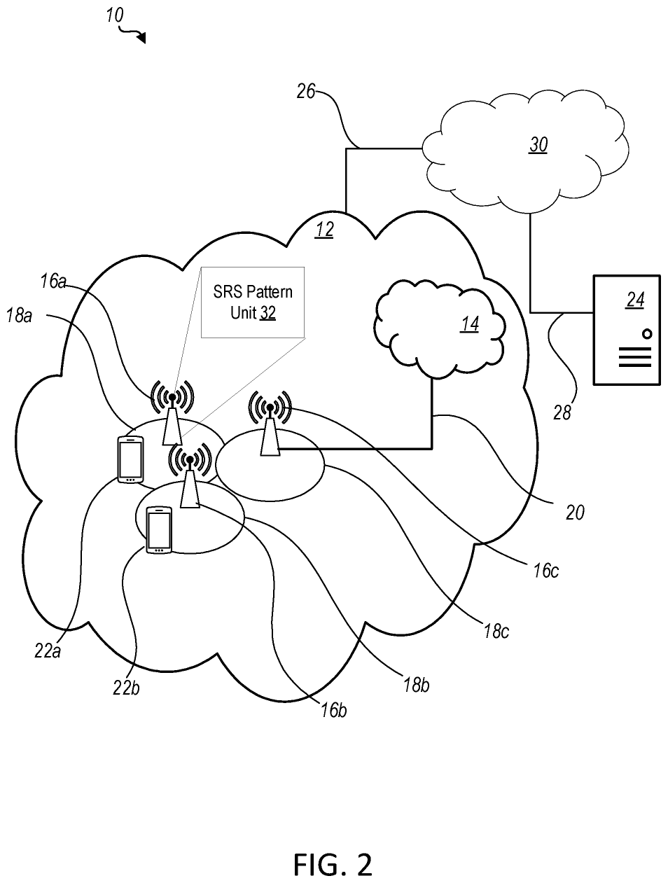

Returning now to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an SRS pattern unit 32 which is configured to cause the network node 16 to determine a sounding reference signal, SRS, pattern within a resource, the SRS pattern being based at least in part on at least one of a comb size, at least one comb offset, at least one cyclic shift and a number of orthogonal frequency division multiplexing, OFDM, symbols within the resource; and optionally, send a configuration specifying the SRS pattern. In some embodiments, the network node 16 is configured to include an SRS pattern unit 32 which is configured to cause the network node 16 to determine a sounding reference signal (SRS) pattern within a resource, each symbol of the SRS pattern being configured to have specific comb offset or cyclic shift.

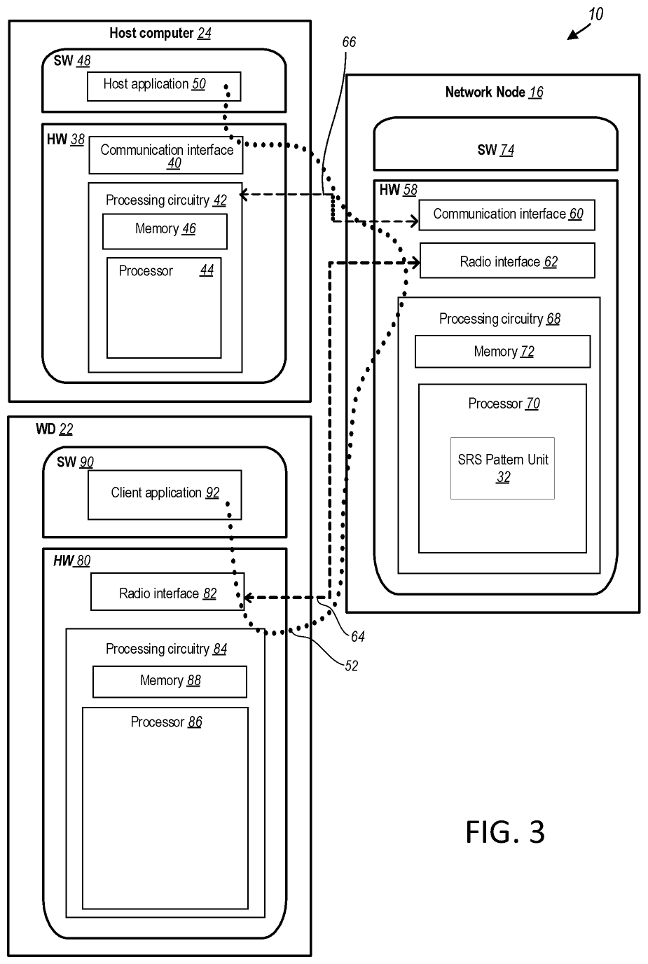

Example implementations, in accordance with an embodiment, of the WD 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include SRS pattern unit 32 which is configured to determine a sounding reference signal (SRS) pattern within a resource, each symbol of the SRS pattern being configured to have specific comb offset or cyclic shift.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 3 and independently, the surrounding network topology may be that of FIG. 3.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as SRS pattern unit 32 as being within a respective processor, it is contemplated that these units may be implemented such that a portion of the unit is stored in a corresponding memory within the processing circuitry. In other words, the units may be implemented in hardware or in a combination of hardware and software within the processing circuitry.

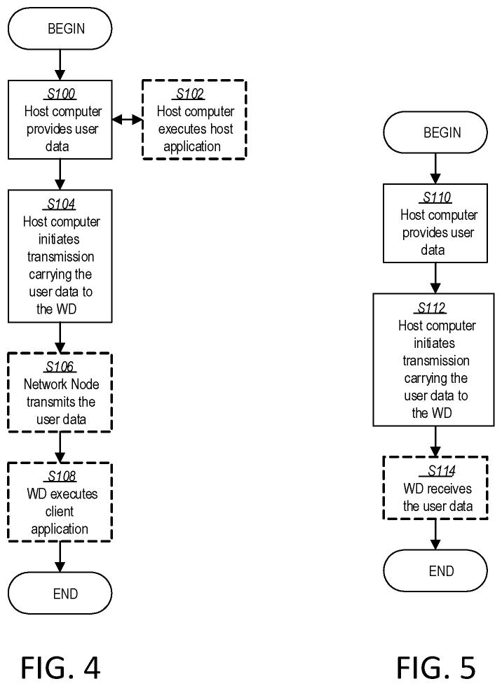

FIG. 4 is a flowchart illustrating an exemplary method implemented in a communication system, such as, for example, the communication system of FIGS. 2 and 4, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an exemplary method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

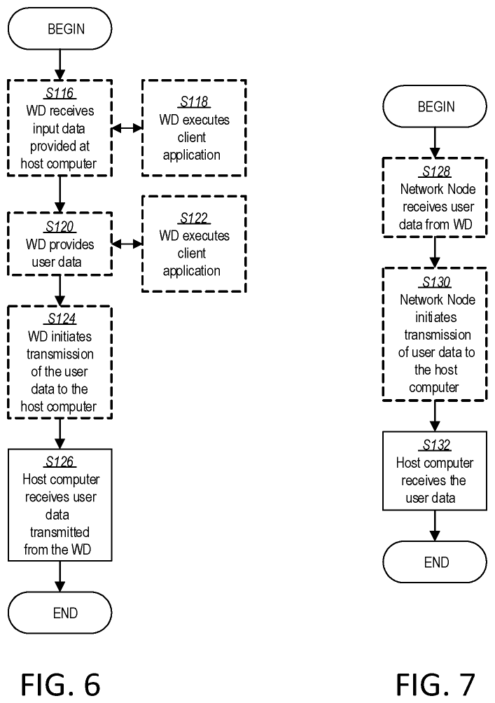

FIG. 6 is a flowchart illustrating an exemplary method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally, or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

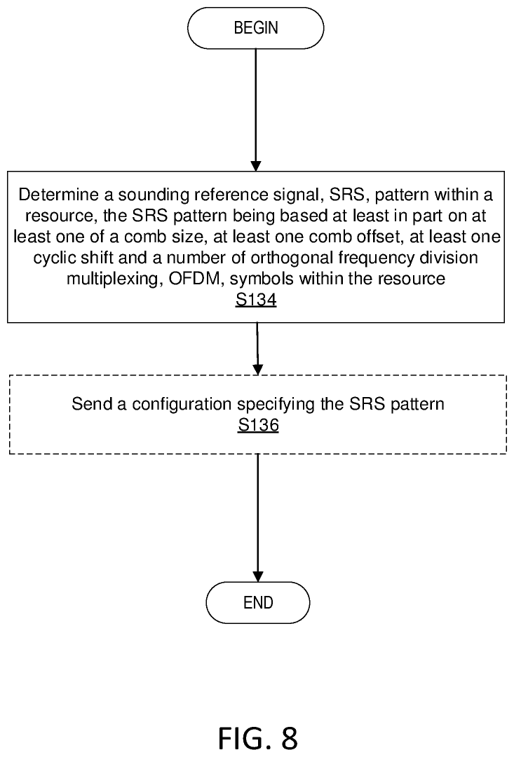

FIG. 8 is a flowchart of an exemplary process in a network node 16 according to some embodiments of the present disclosure. One or more blocks described herein may be performed by one or more elements of network node 16 such as by one or more of processing circuitry 68 (including the SRS pattern unit 32), processor 70, radio interface 62 and/or communication interface 60. Network node 16 such as by one or more of processing circuitry 68 (including the SRS pattern unit 32), processor 70, radio interface 62 and/or communication interface 60 is configured to determine (Block S134) a sounding reference signal, SRS, pattern within a resource, the SRS pattern being based at least in part on at least one of a comb size, at least one comb offset, at least one cyclic shift and a number of orthogonal frequency division multiplexing, OFDM, symbols within the resource. Network node 16 such as by one or more of processing circuitry 68 (including the SRS pattern unit 32), processor 70, radio interface 62 and/or communication interface 60 is configured to optionally, send (Block S136) a configuration specifying the SRS pattern.

In some embodiments, each symbol of the SRS pattern is configured to have a specific comb offset. In some embodiments, the configuration specifying the SRS pattern is a radio resource control, RRC, configuration and at least one symbol of the SRS pattern is configured independently in the RRC configuration. In some embodiments, the configuration specifying the SRS pattern includes a vector, at least one vector element in the vector specifying a comb offset for a corresponding OFDM symbol within the resource. In some embodiments, the SRS pattern is a fixed pattern. In some embodiments, the fixed pattern is dependent on the comb size. In some embodiments, the SRS pattern is one of repeated and truncated based on the number of OFDM symbols that are configured within the resource.

In some embodiments, the configuration specifying the SRS pattern is a radio resource control, RRC, configuration and the SRS pattern is shifted in frequency according to a comb offset parameter in the RRC configuration. In some embodiments, when the comb size is 6, a minimum SRS bandwidth is a multiple of 12 physical resource blocks, PRBs, up to 20 PRBs. In some embodiments, when the comb size is 12, a minimum SRS bandwidth is a multiple of 12 physical resource blocks, PRBs, up to 24 PRBs. In some embodiments, when the comb size is 2, the at least one cyclic shift includes up to 8 cyclic shifts. In some embodiments, when the comb size is 4, the at least one cyclic shift includes up to 12 cyclic shifts.

In some embodiments, network node 16 such as by one or more of processing circuitry 68 (including the SRS pattern unit 32), processor 70, radio interface 62 and/or communication interface 60 is configured to determine a number of orthogonal cyclic shift signals, the number of orthogonal cyclic shift signals being based at least in part on a maximum tolerated delay. In some embodiments, a maximum number of cyclic shifts is a multiple of a number of cyclic shifts in a legacy radio access technology. In some embodiments, a maximum number of cyclic shifts is configured at least one of: as part of a resource configuration of the resource; per resource; and independently of the comb size. In some embodiments, the resource is a single SRS resource configured to have the determined SRS pattern. In some embodiments, network node 16 such as by one or more of processing circuitry 68 (including the SRS pattern unit 32), processor 70, radio interface 62 and/or communication interface 60 is configured to receive an SRS beam on the resource according to the configuration specifying the SRS pattern; and use the received SRS beam for a positioning purpose.

Network node 16 such as via processing circuitry 68 and/or processor 70 and/or radio interface 62 and/or communication interface 60 is configured to determine a sounding reference signal, SRS, pattern within a resource, each symbol of the SRS pattern being configured to have specific comb offset or cyclic shift.

Having described the general process flow of arrangements of the disclosure and having provided examples of hardware and software arrangements for implementing the processes and functions of the disclosure, the sections below provide details and examples of arrangements for sounding reference signal (SRS) configuration for full bandwidth transmission, which may be implemented by network node 16 and/or wireless device 22.

In some embodiments, the configurations discussed below may be considered RRC configurations that may be transmitted and/or determined by the network node 16 and/or received and/or used by the wireless device 22 to transmit SRS according to the techniques disclosed herein.

In some embodiments, there may be at least two ways to construct an SRS pattern within a resource.

In a first embodiment, for full flexibility, each symbol of the SRS resource may be configured with a specific comb offset. This may allow the flexibility to have, for example, a full staggered pattern or another pattern if deemed suitable (for example, the comb offset may be repeated in some or all symbols). Such an approach has obvious advantages in terms of flexibility, but there is a cost in higher configuration overhead. In some embodiments, each symbol is configured (e.g., by network node 16) independently in the SRS RRC configuration. In some embodiments, each symbol is configured (e.g., by network node 16 via a resource configuration) independently from the other symbols in the SRS resource. As stated above, this may allow for good flexibility in the pattern, but may have a higher cost in terms of higher RRC configuration signaling overhead. In some embodiments, the configuration is stored as a vector where each vector element specifies the comb offset for a different symbol in the resource.

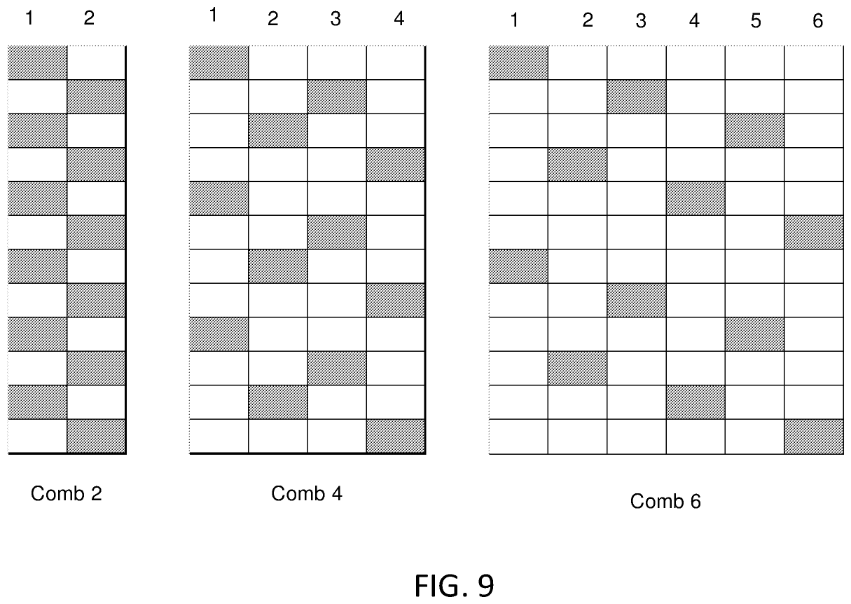

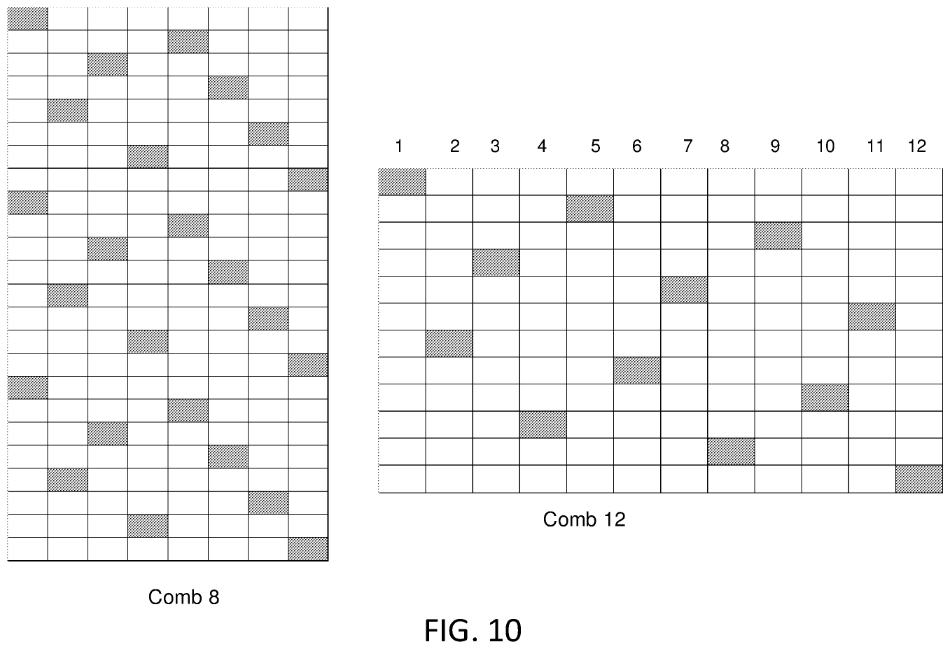

In a second embodiment, a possible configuration is to create a fixed pattern for each comb factor. In one embodiment, the pattern is fixed and the fixed pattern to use may depend on the comb size. FIGS. 9 and 10 show an example of possible patterns alternatives for comb sizes 2, 4, 6, 8 and 12 for example. In some embodiments, the pattern may be truncated or cyclically repeated based on the number of symbols configured e.g., for the resource. In some embodiments, the pattern may be shifted in frequency as a whole by the comb offset parameter in the RRC configuration (called in the RRC ASN code combOffset-nx where x is the comb size, within the transmission comb parameter transmissionComb) of the SRS.

In some embodiments, the patterns allow full coverage of the frequency range over multiple symbols. If the configured number of symbols is less than the pattern size, the appropriate number of symbols are transmitted. The pattern may be such that if the transmitted number of symbols is less than the comb size, the transmitted symbols cover the frequency range as evenly as possible.

Examples of the fixed patterns are as follows. Comb 6 and comb 12 are subject to a further consideration:

The extension to comb 6 and comb 12 has been considered. It was considered not currently feasible to configure comb 6 and comb 12 SRS as the current description of the SRS sequence is not compatible with these comb sizes for the case of low SRS bandwidth, as shown in Table A:

TABLE A
comb factor size and minimum PRB bandwidth

| | Sequence | |
|---|---|---|
| | length for | |
| | min PRB | |
| Comb | bandwidth | Minimum PRB bandwidth for existing sequence |
| factor | of 4 PRBs | length (sequence length in parenthesis) |
| 1 | 48 | 4 PRBs (sequence according to section 5.2.2.1 |
| | | in 3GPP Technical Specification (TS) 38.211) - |
| | | no need for computer generated sequence (CGS) |
| 2 | 24 | 4 PRBs (CG sequence according to table 5.2.2.2-4 |
| | | in TS 38.211) - CGS needed up to 4 PRBs, |
| | | sequence according to 5.2.2.1 in 38.211 |
| | | afterward. |
| 4 | 12 | 4 PRBs (CG sequence according to table 5.2.2.2-2 |
| | | in TS 38.211) - CGS needed up to 8 PRBs, |
| | | sequence according to 5.2.2.1 in 38.211 afterward. |
| 6 | 8 | 12 PRBs (CG sequence according to table 5.2.2.2-4 |
| | | in 38.211) - no CGS available for 16 PRBs - |
| | | sequence according to section 5.2.2.1 in |
| | | TS 38.211 afterward. |
| 8 | 6 | 4 PRBs (CG sequence according to table 5.2.2.2-1 |
| | | in TS 38.211) |
| 12 | 4 | 12 PRBs (CG sequence according to table 5.2.2.2-2 |
| | | in 38.211). afterward, CG sequences available for |
| | | size of 24 PRBs, then from 36 PRBs according to |
| | | section 5.2.2.1 in TS 38.211 |

From Table 1, it can be seen that comb 6 and comb 12 can be used for larger bandwidth than the current minimum bandwidth of 4 PRBs. In an embodiment of Table 1, the minimum SRS bandwidth is set to 4 resource blocks except for comb size 6, where the SRS bandwidth may be a multiple of 12 RBs up to 20 PRBs, and 4 PRB afterward. In another embodiment, the minimum SRS bandwidth is set to 4 resource blocks except for comb size 12, where the SRS bandwidth may be a multiple of 12 RBs up to 24 PRBs and 4 PRBs after that.

Cyclic Shift Allocation for Each SRS

A known specification limits the number of available cyclic shifts to 8 for comb 2 and 12 for comb 4. This allows for multiplexing of up to 48 WDs 22 in the same time-frequency resource (by combining comb and cyclic shift). In the uplink, each WD 22 is assigned a specific SRS resource for transmission. In order to accommodate as many WDs 22 as possible in the shortest possible time, it is of interest to increase the multiplexing of WDs 22 over a single symbol. This can be of interest especially in industrial indoor scenarios where the deployment is favorable to using relatively high combs and number of cyclic shifts and many WDs 22 will share the resources. In a typical 300 square meter (sqm) hall, it is not unreasonable to expect hundred to thousands of WDs 22 managed. In order to allow an efficient use of the time frequency resource, the positioning reference signals cannot take too much of the resource allocation, and therefore multiplexing should be considered when possible.

Comb-based and cyclic shift-based transmissions essentially do the same thing— orthogonality separating the potentially many channel impulse responses that the network nodes 16 estimates from the corresponding many received WD 22 SRS signals. For indoor industrial scenarios at least, a short channel spread is expected so that a large number of cyclic shift/combs could be used without interfering with received WD 22 signals.

The number of UL SRS cyclic shift is specified to be up to 8 for comb-2 and 12 for comb 4, respectively, based on a certain delay spread assumption and cell size as well as the combed symbol unaliased range. Based on the previous discussion, most use cases of interest to SRS-based positioning are indoor, that is to say with a small cell size and delay spread. In this case a tighter spacing of cyclic shifts could be realized, with the largest amount of available cyclic shift being when a full SRS bandwidth signal (or staggered comb pattern) is available, in which case the cyclic shifts could be distributed over the full symbol range.

Table B below is an example showing the number of orthogonal cyclic shift signals tolerating a certain delay for different numerologies, based on a fully staggered comb. Patterns with M<N symbols for a comb-N SRS resource will have a subset of these cyclic shifts available, due to the reduced unaliased symbol duration.

As seen in Table B, the available number of cyclic shifts, at least for frequency 1 (FR1), is much larger than the currently configurable values for SRS. Note that the table considers a comb-1 signal where the whole signal duration can be exploited. Currently, specifications limit the number of cyclic shifts to 8 in comb 2 (i.e., up to 16 WDs 22 can be potentially multiplexed within the SRS symbol duration) and 12 for comb 4 (48 WDs 22 multiplexed in the SRS). In one calculation, considering the delays occurring in an indoor scenario, up to about 130 WDs 22 could be multiplexed in a single symbol (at subcarrier spacing/SCS 15 kHz). This could be achieved with, for example, comb 8 and 24 cyclic shifts (where only a subset of shifts could be used, of the possible 192), comb 4 and 48 cyclic shifts, comb 2 and 96 cyclic shifts, etc. Hence, depending on comb value, the maximum number of cyclic shifts n_{SRS}^{cs,max} may be increased accordingly to reach the maximum available number of cyclic shifts (CS) for the delay incurred by the scenario.

In some embodiments, to avoid issues with legacy, the new maximum number of cyclic shifts may be a multiple of the legacy. In an embodiment, n_{SRS}^{cs,max} possible values are extended to also include 24 and 48. In known systems, n_{SRS}^{cs,max} may be hardcoded to the value of the comb size. While that may be valid for other uses, for the purpose of positioning, the connection between the comb size and the maximum number of cyclic shift may be removed and instead, n_{SRS}^{cs,max} can be configured as part of the resource configuration. In another embodiment, n_{SRS}^{cs,max} may be RRC configured per resource, independently of the comb factor.

In another embodiment, the cyclic shift configured in the resource by the RRC cyclic shift parameter cyclic-shift-nx, where x represents the comb size (2, 4, 6, 8, 12) so that n_{SRS}^{cs}∈{0, 1, 2, . . . , n_{SRS}^{cs,max}−1}.

In a further embodiment a WD 22 could be configured with two existing comb-2 resources, one with v-shift=0 and the other with v-shift=1, thereby forming an effective comb-1. Cyclic shifts could be applied either by treating the two combs independently and exploiting a corresponding half-symbol range for cyclic shifts in each of them, or by treating the two comb-2s as a single comb-1 and exploiting the full symbol range. The total number of orthogonal UL PRSs would be the same in the two cases.

TABLE B
Number of orthogonal cyclic shift signals tolerating
a certain delay for different numerologies.

| | | | | Number of orthogonal cyclic shift | | |
|---|---|---|---|---|---|---|
| | | | | signals tolerating a given delay | | |
| | | | | (assuming comb-1, full | | |
| | | | | bandwidth SRS) | | |
| | | OFDM | | Max 0.5 μs | Max 1 μs | Max 1.5 μs |
| Subcarrier | | symbol length | | delay | delay | delay |
| spacing | | without CP | | (150 m) | (300 m) | (450 m) |
| 15 | kHz | 66.7 | μs | 133 | 67 | 44 |
| 30 | kHz | 33.3 | μs | 67 | 33 | 22 |
| 60 | kHz | 16.7 | μs | 33 | 17 | 11 |
| 120 | kHz | 8.3 | μs | 17 | 8 | 6 |

Some embodiments allow configuration of a full bandwidth SRS within one (e.g., a single) SRS resource.

A higher number of orthogonal UL PRSs can thereby be achieved, which allows for more WDs 22 to be positioned at the same time.

Some embodiments introduce a higher flexibility to the existing SRS signal in the form of:
Allowing the SRS of multiple symbols to form a staggered comb with re-ordered symbols in such a way that stopping reception before the full set of symbols have been received would still allow “best possible” performance.

Some embodiments allow a higher number of orthogonal signals by increasing the number of cyclic shifts, e.g., as a multiple of the legacy number of shifts.

According to one aspect, a network node 16 configured to communicate with a wireless device (WD 22) includes a radio interface 62 and/or processing circuitry 68 configured to determine a sounding reference signal, SRS, pattern within a resource, each symbol of the SRS pattern being configured to have specific comb offset or cyclic shift.

According to this aspect, in some embodiments, the network node 16, the radio interface 62 and/or processing circuitry 68 limits the number of available cyclic shifts. In some embodiments, the cyclic shifts include up to 8 for comb-2 and 12 for comb 4. In some embodiments, a maximum number of cyclic shifts is a multiple of a number of cyclic shifts in a legacy radio access technology, such as Long Term Evolution, LTE.

According to another aspect, a method implemented in a network node 16 includes determining, via the SRS pattern unit 32, a sounding reference signal, SRS, pattern within a resource, each symbol of the SRS pattern being configured to have specific comb offset or cyclic shift

According to this aspect, in some embodiments, the method further includes limiting, via the SRS pattern unit, the number of available cyclic shifts. In some embodiments, the cyclic shifts include up to 8 for comb-2 and 12 for comb 4. In some embodiments, a maximum number of cyclic shifts is a multiple of a number of cyclic shifts in a legacy radio access technology, such as Long Term Evolution, LTE.

Some embodiments may include one or more of the following:

Embodiment A1. A network node configured to communicate with a wireless device (WD), the network node configured to, and/or comprising a radio interface and/or comprising processing circuitry configured to:

determine a sounding reference signal, SRS, pattern within a resource, each symbol of the SRS pattern being configured to have specific comb offset or cyclic shift.

Embodiment A2. The network node of Embodiment A1, wherein the network node, the radio interface and/or processing circuitry limits the number of available cyclic shifts.

Embodiment A3. The network node of any of Embodiments A1 and A2, wherein the cyclic shifts includes up to 8 for comb-2 and 12 for comb 4.

Embodiment A4. The network node of any of Embodiments A1-A3, wherein a maximum number of cyclic shifts is a multiple of a number of cyclic shifts in a legacy radio access technology, such as Long Term Evolution, LTE.

Embodiment B1. A method implemented in a network node, the method comprising:

determining a sounding reference signal, SRS, pattern within a resource, each symbol of the SRS pattern being configured to have specific comb offset or cyclic shift.

Embodiment B2. The method of Embodiment B1, wherein further comprising limiting the number of available cyclic shifts.

Embodiment B3. The method of any of Embodiments B1 and B2, wherein the cyclic shifts include up to 8 for comb-2 and 12 for comb 4.

Embodiment B4. The method of any of Embodiments B1-B3, wherein a maximum number of cyclic shifts is a multiple of a number of cyclic shifts in a legacy radio access technology, such as Long Term Evolution, LTE.

Additional Embodiments and considerations are as follows:

During RAN1#97, the discussion on enhancements to the SRS for positioning resulted in agreements regarding the number of configurable symbols, comb size and staggered pattern. Each of these agreements carried further possible enhancements that are discussed in this paper.

UL SRS Design for Positioning

SRS Configuration

The SRS configuration for UL positioning should follow previous LTE implementation. Similarly to the DL PRS, the SRS configuration supported by a cell is reported via NRPPa to the location server. If a UE is requested to perform e.g. UTDOA or RTT with SRS transmissions, the location server then informs the neighbor cells of the SRS configuration. which in turn, informs the other cells Config via RRC/NRPPa

For Periodic positioning, the configuration is straightforward. The serving cell signals to the location server the configuration(s) it may use for SRS for positioning. Then, when the location server signals to the cell that a UE in this cell (hence, a serving cell) should use SRS, the serving cell configures the UE with SRS resources for positioning via RRC. During the same procedure, the location server should inform non-serving neighbor cells of the SRS configuration. Then the location server requests measurements and obtain reports from the UE via LPP.

Proposal 1: The SRS for positioning is configured by the UE serving cell via RRC

Proposal 2: The SRS for positioning UE configuration is communicated to the UE neighbor (non-serving) cell via NRPPa from the location server

SRS Pattern for Positioning and Resource Allocation

During RAN1#97, the following agreement was reached:

Agreement:

SRS transmissions for positioning are realized with staggered patterns (a collection of SRS symbols from the same antenna port with different offsets for at least some symbols) in a single SRS resource
FFS: construction of the pattern inside the SRS resource structure

There are two ways to construct an SRS pattern within a resource. For full flexibility, one could configure each symbol of the pattern with a specific comb offset. This allows the flexibility to have e.g. a full staggered pattern or another pattern if deemed suitable (for example, the comb offset may be repeated in some or all symbols). Such an approach has obvious advantages in terms of flexibility but cost in configuration overhead.

On the other side a possible configuration is to create a fixed pattern for each comb factor. This pattern could then be truncated or cyclically repeated based on the number of symbols configured. This is a very compact and efficient way of configuring the SRS.

The patterns proposed allow to fully cover the frequency range over multiple symbols. If the configured number of symbols is less than the pattern size, the appropriate number of symbol are transmitted. The pattern is such that if the transmitted number of symbols is less than the comb size, the transmitted symbols cover the frequency range as evenly as possible.

Proposal 3: The SRS configuration for the positioning pattern follows a fixed pattern for each comb size, with a configurable comb offset and number of symbols

The fixed pattern proposed are as shown in FIGS. 9 and 10. Comb 6 and comb 12 are subject to a further agreement:

Number of Symbols in an SRS Resource and Comb Size

The number of symbols in an SRS resource is currently limited to 1,2 or 4 symbols in specifications. During RAN1#96b and RAN1#97, multiple contributions have proposed a higher comb number, with up to comb 12 being proposed. During the RAN1#97 meeting, the following agreements were reached:

Agreement:

For positioning, the number of consecutive OFDM symbols in an SRS resource is configurable with one of the values in the set {1, 2, 4, 8, 12}
FFS: Other values including 3,6,14
Note: Values of 1, 2 and 4 within an SRS resource can already be configured in Rel-15
Agreement:
For positioning, the SRS comb size set is extended from {2,4} to {2,4,8}
FFS: Additional comb sizes: 1, 6, 12
   Note: For the comb sizes of 6 and 12, the number of PRBs may be restricted if currently defined sequences are to be used
FFS: Maximum number of cyclic shifts for the different comb sizes (cyclic shifts for comb sizes of 2 and 4 already exist in Rel-15)

Adding symbols to the SRS resource is useful if
there is a need to accumulate more energy in order to reliably receive the SRS.
When combed transmission is used, it may also be useful to have additional symbols to expand the TOA range (by using multiple, staggered comb offsets in the resource)

Based on this, it is difficult to motivate the use of additional symbol value beside 6 symbols, which could be useful to allow a full-range transmission with comb-6 if comb-6 is agreed. Moreover, including an additional value in the list does not cost any additional signaling overhead as the list already requires 3 bits.

Comb-1 is of interest when the scenario does not allow any multiplexing within a symbol in either the comb dimension or in cyclic shifts. UEs allocated with comb 1 would then be time multiplexed in different symbols. This is the case when the UE speed is such that the channel is not coherent over multiple symbols, and the range over which the UE position should be estimated is about the duration of the symbol. Other cases can be resolve with a combination of comb-based and CS-based multiplexing. Hence, one could see the use of comb-1 as a corner case.

It should be noted that a comb 1 can be realized with the current specification, by specifying two resources with the parameter SRS-SpatialRelationlnfo of the resources involved in creating the comb1 set to the resource ID of one of the SRS resources in the comb.

Observation 1: Comb-1 transmission is only required in cases where the UE needs a large TOA range and has a very short coherence time (high speed)

Observation 2: Comb-1 transmission can already be supported by specification

During RAN1#96b, the extension to comb 6 and comb 12 was also discussed. Comb 6 may be of interest in order to schedule multiple resources over time in a slot. Compared to comb-8, comb-12 would be interesting to add capacity in number of multiplexed UE per symbols. Also, as mentioned in our contribution on DL PRS, higher comb values are more overhead efficient. For the same amount of UEs to schedule, and the same target accuracy and TOA range, a larger comb will yield less overhead.

One concern was that the current description of the SRS sequence is not compatible with these comb sizes for the case of low SRS bandwidth, as shown in table 1:

TABLE 1
comb factor size and minimum PRB bandwidth

| | Sequence | |
|---|---|---|
| | length for | |
| | min PRB | Minimum PRB bandwidth for existing |
| Comb | bandwidth | sequence length (sequence length in |
| factor | of 4 PRBs | parenthesis) |
| 1 | 48 | 4 PRBs (sequence according to 5.2.2.1 in |
| | | 38.211) - no need for CGS |
| 2 | 24 | 4 PRBs (CG sequence according to table |
| | | 5.2.2.2-4 in 38.211) - CGS needed up to |
| | | 4 PRBs, sequence according to 5.2.2.1 in |
| | | 38.211 afterward. |
| 4 | 12 | 4 PRBs (CG sequence according to table |
| | | 5.2.2.2-2 in 38.211) - CGS needed up to |
| | | 8 PRBs, sequence according to 5.2.2.1 in |
| | | 38.211 afterward. |
| 6 | 8 | 12 PRBs (CG sequence according to |
| | | table 5.2.2.2-4 in 38.211) - no CGS |
| | | available for 16 PRBs sequence |
| | | according to 5.2.2.1 in 38.211 afterward. |
| 8 | 6 | 4 PRBs (CG sequence according to table |
| | | 5.2.2.2-1 in 38.211) |
| 12 | 4 | 12 PRBs (CG sequence according to |
| | | table 5.2.2.2-2 in 38.211). afterward, CG |
| | | sequences available for size of 24 PRBs, |
| | | then from 36 PRBs according to 5.2.2.1 |
| | | in 38.211 |

From table 1, it can be seen that comb 6 and comb 12 can be used for larger bandwidth than the current minimum bandwidth of 4 PRBs. It is therefore proposed to allow comb 6 and 12, with the following conditions:

Observation 3: It is possible to use comb 6 for SRS transmission, with the minimum SRS bandwidth to be a multiple of 12 PRBs up to 20 PRBs, and 4 PRBs afterward

Observation 4: It is possible to use comb 12 for SRS transmission, with the minimum SRS bandwidth to be a multiple of 12 PRBs up to 24 PRBs, and 4 PRBs afterward.

Proposal 4: Support comb-6 for SRS transmission

Observation 5: The number of symbols currently supported for transmission of an SRS resource is sufficient for the IOO and UMi channel scenarios

Proposal 5: the number of SRS symbols per resource is extended to 1,2,4,6 and 8 and 12, if comb-6 is to be supported.

Proposal 6: The minimum SRS bandwidth is set to 4 resource blocks except
For comb size 6, the SRS bandwidth shall be a multiple of 12 RBs up to 20 PRBs, and 4 PRB afterward
For comb size 12, the SRS bandwidth shall be a multiple of 12 RBs up to 24 PRBs and 4 PRBs after that

Number of Cyclic Shifts for SRS

In the uplink, each UEs is assigned a specific SRS resource for transmission. In order to accommodate as many UEs as possible in the shortest possible time, it is thus of interest to increase the multiplexing of UEs over a single symbol. This can be of interest especially in industrial indoor scenarios where the deployment is favorable to using relatively high combs and number of cyclic shifts and many UEs will share the resources. In a typical 300 sqm hall, it is not unreasonable to expect hundred to thousands of UEs managed. In order to allow an efficient use of the time frequency resource, the positioning reference signals cannot take too much of the resource allocation, and therefore multiplexing should be considered when possible.

Comb-based and cyclic shift-based transmission essentially do the same thing—separating the UEs by allocating a certain portion of the SRS symbol transmission time. This is illustrated in figure X. For indoor industrial scenarios at least, a short channel spread is expected so that a large amount of cyclic shift/combs could be used without interfering signals between UEs. In our downlink contribution [REF], we discuss the issue of cyclic shifts and combs for DL PRS. The same discussion could be done for UL SRS. The number of UL SRS cyclic shift is specified to be up to 8 for comb-2 and 12 for comb 4, respectively, based on a certain delay spread assumption and cell size as well as the combed symbol unaliased range. Based on the previous discussion, most use cases of interest to SRS-based positioning are indoor, that is to say with a small cell size and delay spread. In this case a tighter spacing of cyclic shifts could be realized, with the largest amount of available cyclic shift being when a full range symbol (i.e. comb-1 or full staggered comb pattern) is available, in which case the cyclic shifts could be distributed over the full symbol range.

Table 2 is reproduced below for convenience and shows the number of orthogonal cyclic shift signals tolerating a certain delay for different numerologies, based on a full-range symbol availability. Patterns with M<N symbols for a comb-N SRS resource will have a subset of these cyclic shifts available, due to the reduced unaliased symbol duration.

As seen in table 2, the available number of cyclic shifts, at least for FR1, is much larger than the currently configurable values for SRS. Note that the table consider a comb-1 signal where the whole signal duration can be exploited. Currently, specifications limit the number of cyclic shifts to 8 in comb 2 (i.e. up to 16 UE can be potentially multiplexed within the SRS symbol duration) and 12 for comb 4 (48 UEs multiplexed in the SRS). In our calculation, considering the delays occurring in an indoor scenario, up to about 130 UEs could be multiplexed in a single symbol (at SCS 15 kHz). This could be achieved with e.g comb 8 and 24 cyclic shifts (where only a subsets of shifts could be used, up to 133 out of 192), comb 4 and 48 shifts, comb 2 and 96 shifts, etc. Hence depending on comb value, the Maximum number of cyclic shifts n_{SRS}^{cs,max} should be increased accordingly to reach the maximum available number of CS for the delay incurred by the scenario. Moreover, in order to avoid issues with legacy, the new maximum number of cyclic shifts should be a multiple of the legacy. Thus it is proposed to increase n_{SRS}^{cs,max} possible values to also include 24 and 48.

Proposal 7: The possible values for the maximum number of cyclic shifts for SRS is increased to [8,12,24,48]

In the current specification, n_{SRS}^{cs,max} is hardcoded to the value of the comb size. While that may be valid for other use, for the purpose of positioning, the connection between the comb size and the maximum number of cyclic shift could be removed and instead n_{SRS}^{cs,max} should be configured as part of the resource configuration.

Proposal 8: Maximum number of cyclic shifts n_{SRS}^{cs,max} and comb size should be independently configured at the resource set level.

Proposal 9: The actual cyclic shift of a SRS resource should be configured by the parameter n_{SRS}^{cs,max} ∈[0, 1, 2, . . . , n_{SRS}^{cs,max}−1}.

TABLE 2
Number of orthogonal cyclic shift signals tolerating
a certain delay for different numerologies.

| | | | | Number of orthogonal cyclic shift | | |
|---|---|---|---|---|---|---|
| | | | | signals tolerating a given delay | | |
| | | | | (assuming comb-1, full | | |
| | | | | bandwidth SRS) | | |
| | | OFDM | | Max 0.5 μs | Max 1 μs | Max 1.5 μs |
| Subcarrier | | symbol length | | delay | delay | delay |
| spacing | | without CP | | (150 m) | (300 m) | (450 m) |
| 15 | kHz | 66.7 | μs | 133 | 67 | 44 |
| 30 | kHz | 33.3 | μs | 67 | 33 | 22 |
| 60 | kHz | 16.7 | μs | 33 | 17 | 11 |
| 120 | kHz | 8.3 | μs | 17 | 8 | 6 |

SRS Usage

During the RAN1 97 meeting, an agreement was reached to have a new usage for positioning in SRS. The pre-existing (rel-15) usages for positioning are as follow:
nonCodebook is aimed, as the name suggests, at enabling non-codebook based PUSCH transmission. This SRS usages is restricted to a single SRS resource set made of up to 4 SRS resources. This SRS configuration is aiming at giving the possibility for the network to confirm or revise the choice of PUSCH precoding by the UE, so that the network can respond by downselecting some of the layers (precoders) selected by the UE via the SRI field in DCI.
Codebook: is aimed at enabling codebook-based transmission of PUSCH. In this usage the SRS is transmitted for reciprocity-based channel sounding, and the network responds to the SRS transmission by sending the suitable precoding matrix to the UE. Only a single resource set may be configured with up to two SRS resources.
beamManagement: is aimed at identifying suitable beam candidates. In this usage, only one resource per resource set may be used at a given time instant.
Antenna switching: is aimed at reciprocity-based DL CSI acquisition via SRS carrier switching.

The SRS for positioning will use most likely use multiple resource sets, with power control configurations targeting different cells based on the path loss between the UE and the measuring cell. Within the resource set, at least in FR2, several resources (beams) may be configured to align with the measuring cell.

Proposal 10: Define a SRS usage for positioning where
The UE may be configured with more than 1 resource set, each with more than one resource (note: may not have a spec impact)
   i. FFS maximum amount of resource sets?
Same Resource may be allocated to more than one resource set
SRS transmission follow the agreed patterns for positioning

### CONCLUSIONS

the following proposals were made:

In the previous sections we made the following observations:

Observation 1 comb-1 transmission is only required in cases where the UE needs a large TOA range and has a very short coherence time (high speed)

Observation 2 Comb-1 transmission can already be supported by specification

Observation 3 It is possible to use comb 6 for SRS transmission, with the minimum SRS bandwidth to be a multiple of 12 PRBs up to 20 PRBs, and 4 PRBs afterward

Observation 4 It is possible to use comb 12 for SRS transmission, with the minimum SRS bandwidth to be a multiple of 12 PRBs up to 24 PRBs, and 4 PRBs afterward.

Observation 5 The number of symbols currently supported for transmission of an SRS resource is sufficient for the IOO and UMi channel scenarios

And the following proposals:

Proposal 1 The SRS for positioning is configured by the UE serving cell via RRC

Proposal 2 The SRS for positioning UE configuration is communicated to the UE neighbor (non-serving) cell via NRPPa from the location server

Proposal 3 The SRS configuration for the positioning pattern follows a fixed pattern for each comb size, with a configurable comb offset and number of symbols

Proposal 4 Support comb-6 for SRS transmission

Proposal 5 the number of SRS symbols per resource is extended to 1,2,4,6 and 8 and 12, if comb-6 is to be supported.

Proposal 6 The minimum SRS bandwidth is set to 4 resource blocks except
For comb size 6, the SRS bandwidth shall be a multiple of 12 RBs up to 20 PRBs, and 4 PRB afterward
For comb size 12, the SRS bandwidth shall be a multiple of 12 RBs up to 24 PRBs and 4 PRBs after that

Proposal 7 The possible values for the maximum number of cyclic shifts for SRS is increased to [8,12,24,48]

Proposal 8 Maximum number of cyclic shifts nSRScs, max and comb size should be independently configured at the resource set level.

Proposal 9 The actual cyclic shift of a SRS resource should be configured by the parameter nSRScs∈0, 1, 2, . . . , nSRScs, max−1.

Proposal 10 Define a SRS usage for positioning where
The UE may be configured with more than 1 resource set, each with more than one resource (note: may not have a spec impact)
i. FFS maximum amount of resource sets?
Same Resource may be allocated to more than one resource set
SRS transmission follow the agreed patterns for positioning

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

Abbreviation Explanation

AD Assistance Data

CSI-RS Channel State Information Reference Signal

LOS Line of Sight

NLOS Non-Line of Sight

NR New Radio

OTDOA Observed Time Difference of Arrival

PRS Positioning Reference Signal

RE Resource Element

RSTD Reference Signal Time Difference

SIB System Information Block

SINR Signal to Interference Noise Ratio

SNR Signal to Noise Ratio

SSB Synchronization Signal Block

TOA Time of Arrival

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented in a wireless device, the method comprising:
receiving a configuration from a network node configuring a sounding reference signal, SRS, pattern within a resource, the SRS pattern being based at least in part on at least one of a comb size, at least one comb offset, at least one cyclic shift and a number of orthogonal frequency division multiplexing, OFDM, symbols within the resource; and
transmitting a SRS to the network node using the SRS pattern.

2. The method of claim 1, wherein each symbol of the SRS pattern is configured to have a specific comb offset.

3. The method of claim 2, wherein the configuration specifying the SRS pattern is a radio resource control, RRC, configuration and at least one symbol of the SRS pattern is configured independently in the RRC configuration.

4. The method of claim 2, wherein the configuration specifying the SRS pattern includes a vector, at least one vector element in the vector specifying a comb offset for a corresponding OFDM symbol within the resource.

5. The method of claim 1, wherein the SRS pattern is a fixed pattern.

6. The method of claim 5, wherein the fixed pattern is dependent on the comb size.

7. The method of claim 5, wherein the SRS pattern is one of repeated and truncated based on the number of OFDM symbols that are configured within the resource.

8. The method of claim 5, wherein the configuration specifying the SRS pattern is a radio resource control, RRC, configuration and the SRS pattern is shifted in frequency according to a comb offset parameter in the RRC configuration.

9. The method of claim 1, wherein, when the comb size is 6, a minimum SRS bandwidth is a multiple of 12 physical resource blocks, PRBs, up to 20 PRBs.

10. The method of claim 1, wherein, when the comb size is 12, a minimum SRS bandwidth is a multiple of 12 physical resource blocks, PRBs, up to 24 PRBs.

11. The method of claim 1, wherein, when the comb size is 2, the at least one cyclic shift includes up to 8 cyclic shifts.

12.-17. (canceled)

18. A wireless device configured to communicate with a network node, the wireless device comprising processing circuitry, the processing circuitry configured to cause the wireless device to:
receive a configuration from a network node to configure a sounding reference signal, SRS, pattern within a resource, the SRS pattern being based at least in part on at least one of a comb size, at least one comb offset, at least one cyclic shift and a number of orthogonal frequency division multiplexing, OFDM, symbols within the resource; and
transmit a SRS to the network node using the SRS pattern.

19. The wireless device of claim 18, wherein each symbol of the SRS pattern is configured to have a specific comb offset.

20. The wireless device of claim 19, wherein the configuration specifying the SRS pattern is a radio resource control, RRC, configuration and at least one symbol of the SRS pattern is configured independently in the RRC configuration.

21. The wireless device of claim 19, wherein the configuration specifying the SRS pattern includes a vector, at least one vector element in the vector specifying a comb offset for a corresponding OFDM symbol within the resource.

22. The wireless device of claim 18, wherein the SRS pattern is a fixed pattern.

23. The wireless device of claim 22, wherein the fixed pattern is dependent on the comb size.

24. The wireless device of claim 22, wherein the SRS pattern is one of repeated and truncated based on the number of OFDM symbols that are configured within the resource.

25. The wireless device of claim 22, wherein the configuration specifying the SRS pattern is a radio resource control, RRC, configuration and the SRS pattern is shifted in frequency according to a comb offset parameter in the RRC configuration.

26. The wireless device of claim 18, wherein, when the comb size is 6, a minimum SRS bandwidth is a multiple of 12 physical resource blocks, PRBs, up to 20 PRBs.

27. The wireless device of claim 18, wherein, when the comb size is 12, a minimum SRS bandwidth is a multiple of 12 physical resource blocks, PRBs, up to 24 PRBs.

28. The wireless device of claim 18, wherein, when the comb size is 2, the at least one cyclic shift includes up to 8 cyclic shifts.

29.-34. (canceled)
